(19) United States
(12) Patent Application Publication
(10) Pub. No.: US 2005/0077425 A1
(43) Pub. Date: Apr. 14, 2005

(54) Thruster for propelling and directing a vehicle without interacting with environment and method for making the same

(76) Inventor: Raymond Payette, Ste-Foy (CA)

Correspondence Address: BAKER & HOSTETLER LLP, Washington Square, Suite 1100, 1050 Connecticut Avenue, N.W., WASHINGTON, DC, 20036, US

(21) Appl. No.: 10/682,726

(22) Filed: Oct. 10, 2003

(51) Int. Cl. B64C 27/00

(52) U.S. Cl. 244/62

(57) ABSTRACT

A thruster for propelling and directing a vehicle without interacting with its environment without using propellant and particularly adapted for use in space, comprising rotating means having a pair of a first and a second axes of rotation, connectable to the vehicle such that each of the first and second axes of rotation extends opposite to each other with respect to a center of mass of the vehicle. The thruster is also provided with actuator means for actuating a first and a second rotational movement of the rotating means respectively around each of the first and second axis of rotation. The first rotational movement is actuated in a clockwise direction thereby generating a first reacting torque in a counter-clockwise direction that causes a pivotal movement of the vehicle around the first axis of rotation in the counter-clockwise direction. The second rotational movement is actuated in a counter-clockwise direction thereby generating a second reacting torque in a clockwise direction that causes a pivotal movement of the vehicle around the second axis of rotation in the clockwise direction. The thruster is also provided with a control mechanism to control and coordinate the actuator means to impart propulsion and direction to the vehicle. In a further embodiment, the thruster is enclosed. In a further embodiment, the thruster allows to spin the vehicle. A method for propelling and directing a vehicle without interacting with its environment is also disclosed.

### FIELD OF THE INVENTION

This invention relates generally to a propulsion system and, more particularly, it concerns a thruster for propelling and directing a vehicle without interacting with environment. It has particular utility in the propulsion of space vehicle. It also concerns a method for propelling and directing a vehicle without interacting with environment.

### BACKGROUND OF THE INVENTION

The thruster for propelling and directing a vehicle of the present invention is distinct from and overcomes several disadvantages of the prior art in that it does not require the use of propellant, and is therefore particularly adapted for space travel, as will be discussed in details below.

The present invention is based on a branch of physics known as classical mechanics. Classical mechanics deals with the natural laws of motion, and is often associated with the work of Sir Isaac Newton, which realized that for every force exerted on a body, there is an equal but opposite reactive force. This principle is currently known as Newton's third law of motion.

This principle is the basis for all manner of propulsion, including walking, jet travel and rocketry. For example, in a car, the motive force is applied to the friction of a revolving tire on the road surface. In a motorboat, the turning propeller forces water toward the boat's stern, thereby propelling the boat forward. In a jet plane, the jet engine forces air and fuel toward the rear of the plane, creating a thrust that moves the plane forward. Another means of propulsion in the atmosphere is with the use of balloons that expand in the air to drive itself upwards towards a stratum of air that is less dense.

In space, which is characterized by the near absence of air and by less planetary gravitation, a rocket propels itself through space by expelling matter in the form of burning propellant. The expulsion of matter through the tail of the rocket creates an equal but opposite force, called thrust, that propels the rocket forward in the desired direction.

For each mode of transportation, the force or thrust pushing the vehicle forward is the result of an action-reaction force interchange. This process relies on the existence of some external mass (such as water, air, road surface or discharging rocket fuel) against which the vehicle may impart a force. This force pushes the external mass in one direction, and the vehicle in the opposite direction, thereby propelling the vehicle as desired.

The energy of a moving vehicle such as a car or a jet is called “kinetic” energy. Vehicles use on-board engines (such as automobile motors or jet engines) to convert the “potential” energy in fuel into kinetic energy. Specifically, the consumption of fuel is used to move the engine (often in a rotating direction). The movement of the engine is converted into movement of the vehicle via a prop (in the case of a boat or plane) or drive transmission (in the case of a land vehicle).

On Earth, there is usually no shortage of external mass (such as water, air, or ground) against which a vehicle or other object may be propelled.

Because space is a vacuum, a vehicle that will move through space in a controlled manner must bring along its own external mass in the form of propellant that is discharged to provide moving thrust. The difficulty is, propellant is quickly exhausted, leaving the vehicle adrift without any motive power. This makes space travel over long distances extremely difficult.

For example, a rocket travelling to the moon must bring many tons of propellant to both accelerate away from earth and decelerate upon arriving at the moon. If there were a way for rockets to propel themselves through space without having to discharge propellant, it would greatly reduce the cost and difficulty of space travel.

Satellites or spacecraft orbiting the earth are today a widely used technique for many applications such as weather data collection and communications for example. As these applications have become increasingly complex, they have resulted in a demand for payloads that are more powerful and hence more massive spacecraft. However, heavier spacecraft are increasingly more difficult and expensive to place, and then maintain, on orbit.

A typical spacecraft is placed on orbit by a combination of a launch vehicle and its own propulsion systems. A launch vehicle will propel and release the spacecraft in an initial lower orbit about the earth. Once in this initial lower orbit, the spacecraft propulsion system will be responsible for propelling the spacecraft to its final orbit.

A launch vehicle has a limited lift capability, beyond which, it will not be capable of delivering the spacecraft to an acceptable orbit. The lift limit is the maximum spacecraft separation mass, i.e., the sum of the spacecraft's fuel and dry mass. Generally, the more lift capability is required, the larger and more expensive is the launch vehicle. Thus as the mass of a spacecraft increases during the design process, the availability of the less capable, inexpensive launch vehicles decreases. There is a real desire to maintain compatibility with a broad range of less capable and inexpensive launch vehicles as spacecraft dry mass increases. Clearly, if the dry mass of a spacecraft increases, then its fuel mass must decrease to remain compatible with inexpensive launch vehicles.

Once on station the propulsion system is responsible for maintaining the orbit throughout the life of the mission. Commonly, spacecrafts orbit the earth at the same revolution rate as the earth spins. These spacecrafts and corresponding orbits are referred to as “synchronous” or “geosynchronous”. When the synchronous orbit lies in the plane of the earth's equator, the synchronous spacecraft is also called geostationary and operates within a “stationary” orbit. It is generally well known in the art that various forces act on synchronous spacecraft that move the spacecraft out of a desired orbit. These forces are due to several sources including the gravitational effects of the sun and moon, the elliptical shape of the earth, and solar radiation pressure. To counter these forces, synchronous spacecrafts are equipped with propulsion systems that are fired at intervals in order to maintain station at a desired geostationary and longitudinal location. This maintenance requires control of the inclination, eccentricity, and drift of the spacecraft. The orbit's inclination defines the north-south position of the spacecraft relative to the earth's equator. Eccentricity is the measure of the non-circularity of the spacecraft orbit. That is, the measure of the variation of the distance the spacecraft is from the center of the earth as the spacecraft moves around its orbit. Drift is the measure of the difference in longitude of the spacecraft's sub-satellite point and the desired geostationary longitude as time progresses.

Moreover, once on station, a spacecraft must maintain its attitude in addition to its orbital position. This orbital maintenance is essential for geosynchronous communications spacecraft in which communication hardware must be pointed to a selected planetary location. Disturbance torques, such as solar pressure, work to produce undesired spacecraft attitude motion and stabilization systems must be used to counteract such disturbance torques.

Spacecrafts generally use small retro rockets to change the direction it faces or the manner in which it rotates. When the satellite exhausts its supply of fuel, its orientation can no longer be controlled. When this happens, the satellite is often permanently inoperable. Because millions of dollars are invested in building and launching the satellites, it would be very valuable if satellite life were prolonged by a new way to manoeuvre the satellite without expelling physical propellant.

Other stabilization systems currently used typically include an arrangement of reaction wheels. These reaction wheels have to be periodically desaturated or unloaded and desaturation is typically accomplished by applying an external torque to the spacecraft through propulsion thrusting, thereby requiring even more fuel.

Another concern to take into consideration is the simulation of earth's gravity in a space station. To simulate earth's gravity for the benefit of the station's occupants, the station would be rotated about a central axis. The centrifugal force experienced by someone at the peripheral of the rotating station would feel like gravity. The difficulty is, the only known way to set a large body such as a space station into spinning motion about its own axis is by placing retrorockets about the station's perimeter, and directing the rockets' thrust in a direction tangential to the desired arc of rotation. Depending on the weight of the station, this process would consume an exorbitant amount of propellant. Thus, it would be desirable to spin a space station without using propellant.

It is in fact currently possible to control the rotation of satellites to some extent without having to expel propellant. In accordance with this technique, a flywheel on board the satellite is rotated or accelerated to change or correct the rotational momentum of the satellite. The difficulty with these existing techniques is that once the flywheel is rotated or accelerated, it cannot be returned to its previous orientation or speed without offsetting the first change or correction. Thus, existing devices are of limited use. There is therefore a need to spin a space station without using propellant in a more convenient manner.

As explained above, in space, the cost of bringing fuel is considerable. Thus, other means for propelling a vehicle in that environment have been explored. A system working with solar energy would sustain acceleration far longer than a rocket. However the farther away it travels from the sun, the less energy it can generate. Propulsion by solar wind produces very little energy for its mass and volume. Furthermore, their very large membranes can tear easily, can build up static electricity, are apt to degrade under ultraviolet light and melt easily. Any very large structure is vulnerable, difficult to maintain and is unlikely to have much redundancy. A propulsion system using solar energy but having a strong force per mass and volume would be near ideal for planetary space travel. Unfortunately, none satisfactory propulsion system based on solar energy have been developed yet.

A number of patents describing propulsion system particularly adapted for space travel have been obtained. Some of them rely on oscillation thrusters. Such devices require friction and their motion is the resulting difference between moving friction and static friction. Indeed, they would not be useful in space where static friction cannot be used for traction. Other patents have been obtained using gyroscopic precession, some even claiming antigravity properties. They have been proven to violate the law of conservation of momentum and, therefore, cannot be used for propulsion in space. Nevertheless, it is worth mentioning that gyroscopic mechanisms are used in space for navigational and stabilization purposes, because they can maintain a set direction.

These prior art propulsion systems are described in the following U.S. Pat Nos. 6,435,457; 6,345,789; 6,293,501; 6,234,267; 6,089,511; 6,032,904; 6,021,979; 5,996,942; 5,966,986; 5,860,317, 5,850,992; 5,831,354; 5,723,923; 5,697,582; 5,685,196; 5,557,988; 5,520,359; 5,145,130; 4,836,470; 4,087,064 and 3,893,573; in JP 11-321786 Japanese patent and in 2003/0010141; 2002/0194939; 2002/0069941; 2001/0035059; 2001/0032746 and 2001/0032522 US patent applications.

Therefore, there is still a need for a convenient propulsion system that does not require using propellant to propel a vehicle. Moreover, as explained above, it would be desirable that such a propulsion system would allow a space vehicle to spin in a convenient manner and without using propellant.

Inasmuch as a “nanomotor” has already been patented in Germany (DE 4342314C2) and with the progress of “nanobiotechnology” and “nanotechnology”, there might be a need for a self-contained thruster that would guide a medical product through the cardio-vascular system. This propulsion system would be advantageous in that it doesn't interact with its environment so it would have less chance of becoming entangled with something else next to it, particularly if it is enclosed.

The present invention could be used to propel submarines and other vessels without any propeller or rudder, thus eliminating the turbulence they cause. This would enhance the stealth of submarines and other vessels.

### SUMMARY OF THE INVENTION

An object of the present invention is to provide a thruster for propelling and directing a vehicle without interacting with environment that satisfies the aforesaid needs.

Accordingly, the present invention is directed to a thruster for propelling a vehicle without interacting with environment comprising rotating means having a pair of a first and a second axis of rotation. The rotating means is connectable to the vehicle such that each of the first and second axes of rotation extends opposite to each other with respect to a center of mass of the vehicle. The thruster is also provided with actuator means for actuating a first and a second rotational movement of the rotating means, respectively around each of the first and second axes of rotation. The first rotational movement is actuated in a clockwise direction thereby generating a first reacting torque in a counter-clockwise direction that causes a pivotal movement of the vehicle around the first axis of rotation in the counter-clockwise direction. The second rotational movement is actuated in a counter-clockwise direction thereby generating a second reacting torque in a clockwise direction that causes a pivotal movement of the vehicle around the second axis of rotation in the clockwise direction. The thruster is also provided with a control mechanism to control and coordinate the actuator means to propel the vehicle.

In one embodiment of the invention, the rotating means further has a second pair of axes of rotation. Each of the axes of rotation of the second pair extends opposite to each other with respect to the center of mass of the vehicle. Each of the pairs extends respectively substantially transversally and longitudinally on the vehicle for allowing a two dimensional propulsion of the vehicle.

In another embodiment of the invention, the rotating means further has a third pair of axes of rotation. Each of the axes of rotation of the third pair extends opposite to each other with respect to the center of mass of the vehicle. The third pair extends substantially perpendicularly to the second pair for allowing the propulsion of the vehicle in a three dimensional environment.

In a further embodiment of the invention wherein the rotating means comprises a first and a second reaction wheels, the thruster is further provided with a manipulator having a yaw joint. The first and second reaction wheels are mounted on the manipulator for allowing a permutation of each of the first and second reaction wheels along the first and second axes of rotation. This embodiment allows the reaction wheels momentum unloading procedure.

In another further embodiment of the invention, the thruster is enclosed from its environment with a housing, a coating or encapsulated.

In another further embodiment of the invention, the thruster is provided with a particular arrangement of reaction wheels causing spinning of the vehicle. Indeed, each of the first and second axes of rotation is associated with an additional adjacent twin axis of rotation parallel thereto and off-centered from the center of mass of the vehicle. The rotating means further comprises a first, a second, a first twin and a second twin reaction wheels. Each of the reaction wheels respectively extends along one of the axes of rotation. The thruster further comprises a manipulator having two rotating arms, each respectively receiving one of the first and second reaction wheels and the corresponding twin reaction wheel for respectively rotating the corresponding axes of rotation around each other, thereby rotating the corresponding reaction wheels around each other.

Another object of the present invention is to provide a method for propelling and directing a vehicle without interacting with environment. Accordingly, the method comprises the steps of:
actuating a first rotational movement in a clockwise direction around a first axis of rotation off-centered from a center of mass of the vehicle thereby generating a first reacting torque in a counter-clockwise direction which causes a pivotal movement of the vehicle around the first axis of rotation in the counter-clockwise direction;
actuating a second rotational movement in a counter-clockwise direction around a second axis of rotation off-centered from the center of mass of the vehicle and extending opposite to the first axis of rotation with respect to the center of mass of the vehicle, the second rotational movement generating a second reacting torque in a clockwise direction which causes a pivotal movement of the vehicle around the second axis of rotation in the clockwise direction; and
controlling an actuating of the first and second rotational movements to impart propulsion and direction to the vehicle.

In a further embodiment, the method for propelling and directing a vehicle without interacting with environment allows the reaction wheel momentum unloading procedure. Accordingly, in this method a first and a second reaction wheels respectively generate each of the first and second rotational movements. Each of the reaction wheels extends along one of the first and second axes of rotation. The reaction wheels are mounted on a manipulator having a yaw joint for permuting each of the reaction wheels along the first and second axis of rotation. The method further comprises the step of unloading a momentum of at least one of the reaction wheels. The step of unloading a momentum comprises the sub-steps of:
permuting each of the reaction wheels along the first and second axes of rotation; and
reversing the direction of rotation of each of the reaction wheels thereby allowing a momentum unloading of each of the reaction wheels while propelling the vehicle in a previous direction.

In another further embodiment, the method allows to spin the vehicle. Accordingly, in this method, each of the first and second axes of rotation is associated with an additional adjacent twin axis of rotation parallel thereto and off-centered from the center of mass of the vehicle. The rotating means further comprises a first, a second, a first twin and a second twin reaction wheel. Each of the reaction wheels respectively extends along one of the axes of rotation. The method further comprises the step of spinning the vehicle. The step of spinning the vehicle comprises the sub-steps of:
rotating the first and the corresponding twin axes of rotation around each other for rotating the corresponding reaction wheels around each other; and
rotating the second and the corresponding twin axes of rotation around each other for rotating the corresponding reaction wheels around each other, thereby generating an angular momentum spinning the vehicle.

### BRIEF DESCRIPTION OF THE DRAWINGS

These and other objects and advantages of the invention will become apparent upon reading the detailed description and upon referring to the drawings in which:

FIG. 1 is a perspective view of a thruster for propelling and directing a vehicle without interacting with its environment according to a preferred embodiment of the present invention.

FIG. 2 is a schematic diagram showing the displacement of a vehicle on which a thruster of the present invention is mounted.

FIG. 3 is a perspective view of a thruster for propelling and directing a vehicle without interacting with its environment according to another preferred embodiment of the present invention.

FIG. 4 is a perspective view of the thruster of FIG. 3 wherein the rotating means has been rotated.

FIG. 5 is a front view of a thruster for propelling and directing a vehicle without interacting with its environment according to another preferred embodiment of the present invention.

FIG. 6 is a perspective view of a thruster for propelling and directing a vehicle without interacting with its environment according to another preferred embodiment of the present invention.

FIG. 7 is a perspective view of a thruster for propelling and directing a vehicle without interacting with its environment according to another preferred embodiment of the present invention.

FIG. 8 is a perspective view of the thruster of FIG. 7 wherein the rotating means has been rotated.

FIG. 9 is a perspective view of a thruster for propelling and directing a vehicle without interacting with its environment according to another preferred embodiment of the present invention.

FIG. 10 is a perspective view of a thruster for propelling and directing a vehicle without interacting with its environment according to another preferred embodiment of the present invention.

FIG. 11 is a perspective view of a vehicle on which a thruster for propelling and directing a vehicle without interacting with its environment of the present invention has been mounted.

FIG. 12 is a top view of the vehicle of FIG. 11 illustrating a displacement thereof.

FIGS. 13A to 13D are schematic diagrams illustrating forces propelling the vehicle of FIG. 11.

FIG. 14 is a perspective view of a vehicle on which a thruster for propelling and directing a vehicle without interacting with its environment of the present invention has been mounted.

FIG. 15 is a perspective view of the vehicle of FIG. 14 that has been rotated.

FIG. 16 is a perspective view of a vehicle on which a thruster for propelling and directing a vehicle without interacting with its environment of the present invention has been mounted.

FIG. 17 is a perspective view of the vehicle of FIG. 16 wherein the thruster has been rotated.

FIG. 18 is a perspective view of a vehicle on which a thruster for propelling and directing a vehicle without interacting with its environment of the present invention has been mounted.

FIG. 19 is a perspective view of a vehicle on which a thruster for propelling and directing a vehicle without interacting with its environment of the present invention has been mounted.

FIG. 20 is a perspective view of a vehicle on which a thruster for propelling and directing a vehicle without interacting with its environment of the present invention has been mounted.

While the invention will be described in conjunction with various embodiments, it will be understood that it is not intended to limit the scope of the invention to such embodiments. Rather, it is intended to cover all variations, modifications and equivalents as may be included as defined by the appended claims.

### DETAILED DESCRIPTION OF PREFERRED EMBODIMENTS

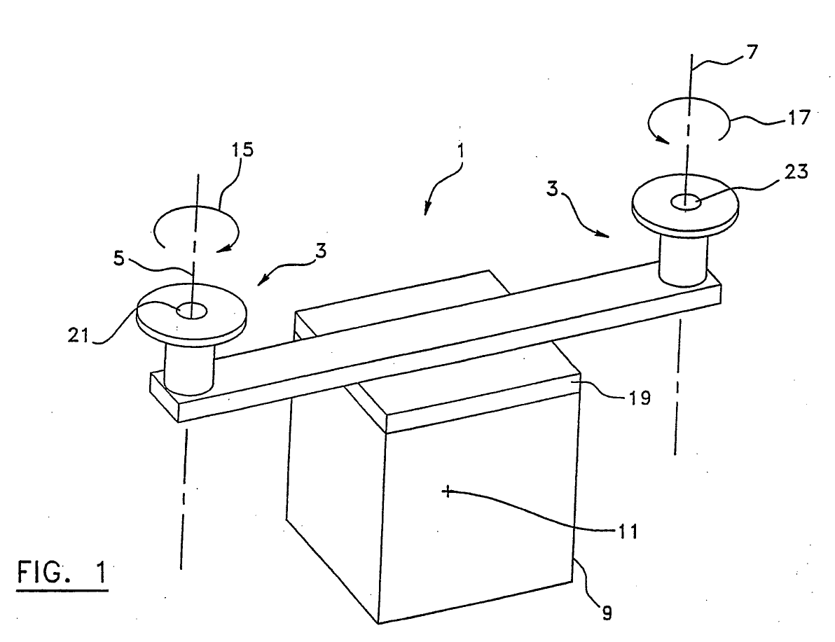

In the following description, similar features in the drawings have been given similar reference numerals and in order to lighten the figures, some elements are not referred to in some FIGS. 1f they were already identified in a precedent figure.

As mentioned previously, the present invention relates to a thruster for propelling and directing a vehicle without interacting with its environment. It should be understood that throughout the present description, the expression “without interacting with environment” is intended to means that the present thruster does not need to rely on surroundings such as air to propel the vehicle. Indeed, the thruster of the present invention can be used in a frictionless environment such as space for example.

The present thruster may advantageously be used in several applications such as for the propulsion and direction of a terrestrial vehicle, a nautical vehicle such as a submarine, a “nanotechnological” device or for the propulsion and directing of a hovercraft for non-limitative examples. Nevertheless, the thruster of the present invention is particularly adapted for use in space, where the consumption of fuel is an important concern.

The present invention alleviates the most glaring problem of the prior art, viz. the high consumption of fuel for propelling a vehicle, since the present thruster does not require propellant to propel and direct the vehicle.

The present invention uses elementary physics to explain its operation, namely Newton's third law of motion stating that for every action there is an equal and opposite reaction.

Linear motion physics are similar to rotational motion physics, known as angular motion physics. For example linear distance, measured in feet or meters, is analogous to radians. Thus when a vehicle accelerates and then decelerates in a linear fashion, it has been displaced because it has done some work. This is also true for rotational motion where a rotational displacement will be the result.

The essence of this invention is to combine rotations about different axes. When different rotations applied to different axis are produced on a body the result can be represented as a vector addition.

When a torque is applied to a rotor, a reacting torque counteracts it. The reaction torque is necessarily on the same axis, of the same force but in opposite direction as the applied torque; it is always centered on the same axis as the original torque.

The moment of inertia is a function of an object's mass and of the radius from its axis depending on its shape. If it is a cylinder, the equation is I=½ mr²; if it's a hoop or a point mass, the equation is I=mr², where m is the object's mass and r the radius. Thus, whatever its shape, the greater the distance of the load's center of inertia is located from the rotating axis, the greater the torque required to move it and the greater the reaction torque produced.

Referring to FIG. 1, there is shown a first preferred embodiment of a thruster for propelling and directing a vehicle without interacting with its environment according to the present invention. The thruster 1 comprises rotating means 3 having a pair of a first and a second axis of rotation 5, 7. Preferably, the first and the second axes of rotation 5, 7 extend in a substantially parallel relationship. The rotating means 3 is connected to the vehicle 9 such that each of the first and second axes of rotation 5, 7 extends opposite to each other with respect to a center of mass 11 of the vehicle 9. Preferably, the rotating means 3 comprises a first and a second rotor 21, 23, each respectively extending along one of the first and second axes of rotation 5, 7. The first and the second rotors 21, 23 are preferably coplanar, as illustrated, but others arrangements could also be devised. The thruster 1 is also provided with actuator means for actuating a first and a second rotational movements 15, 17 of the rotating means 3 respectively around each of the first and second axes of rotation 5, 7. Preferably, the actuator means comprises an electrical motor. A plurality of motors, each being associated with one of the rotors may also be conveniently used. The thruster 1 may also be provided with a power supply operatively connected to the actuator means. The first rotational movement 15 is actuated in a clockwise direction thereby generating a first reacting torque in a counter-clockwise direction that causes a pivotal movement of the vehicle 9 around the first axis of rotation 5 in the counter-clockwise direction. The second rotational movement 17 is actuated in a counter-clockwise direction thereby generating a second reacting torque in a clockwise direction that causes a pivotal movement of the vehicle 9 around the second axis of rotation 7 in the clockwise direction. The thruster 1 is also provided with a control mechanism 19 to control and coordinate the actuator means to impart propulsion and direction to the vehicle 9.

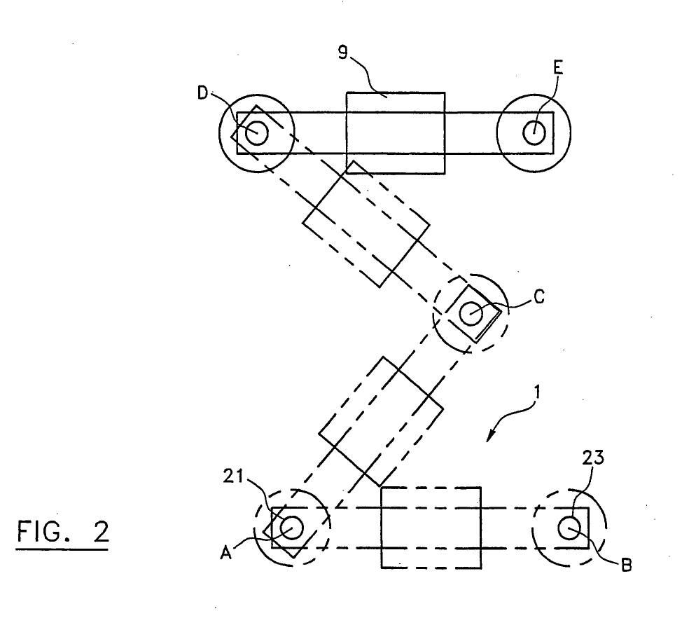

FIG. 2 shows several rotational displacements of a vehicle equipped with the thruster 1 of the present invention resulting in vehicle propulsion. The vehicle 9 is initially located on A-B. A rotational movement of the rotor 21 is actuated, thereby generating a reacting torque that rotates the vehicle 9 from initial position A-B to position A-C. The rotor 23 is then actuated thereby generating another reacting torque that rotates the vehicle 9 from position A-C to position D-C. The rotor 21 is actuated once again, thereby generating a reacting torque that rotates the vehicle 9 from position D-C to position D-E. Thus, the net displacement is to translate the vehicle 9 from its initial position A-B to its final position D-E in this case, but it could also have rotated the vehicle.

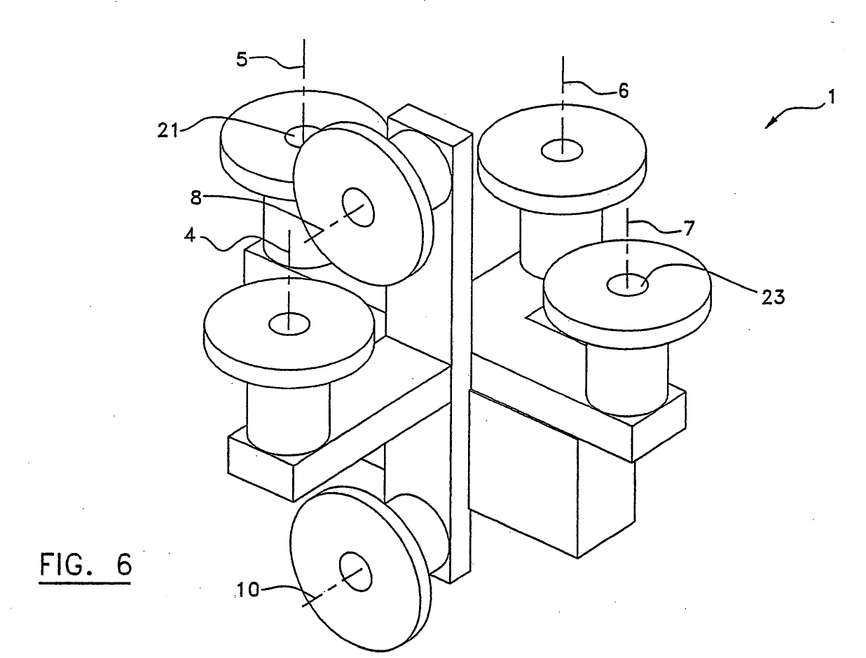

For allowing two-dimensional propulsion and direction of the vehicle, the rotating means may advantageously have a second pair consisting of a first and a second axes of rotation 4, 6, as can be seen on FIG. 6. Each of the axes of rotation of the second pair extends opposite to each other with respect to the center of mass of the vehicle. Each of the pairs extends respectively substantially transversally and longitudinally on the vehicle.

For allowing any displacement of the vehicle in a three dimensional environment, the rotating means may also advantageously be provided with a third pair consisting of a first and a second axes of rotation 8, 10. Each of the axes of rotation of the third pair extends opposite to each other with respect to the center of mass of the vehicle. The third pair extends substantially normally to the second pair as can be better appreciated in FIG. 6.

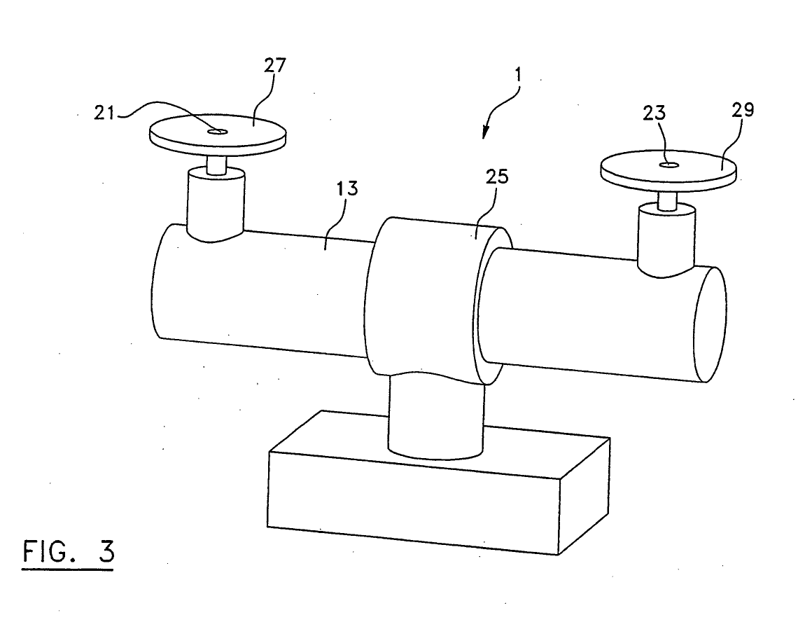

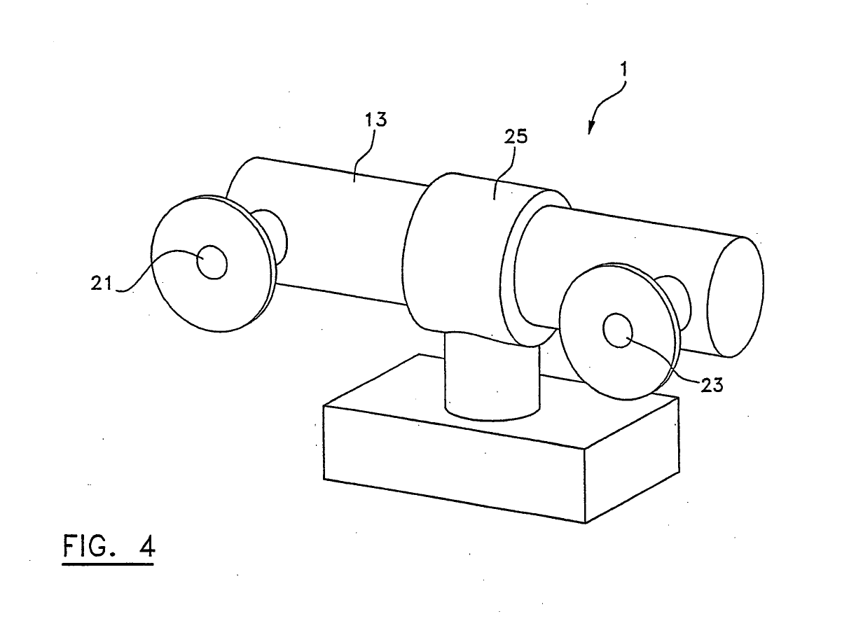

FIG. 3 shows another preferred embodiment of the thruster 1 of the present invention. In this embodiment, the rotating means comprises a first and a second rotor 21, 23, each respectively extending along each of the first and second axes of rotation of the first pair of axes. The thruster 1 is further provided with a manipulator 13 for sequentially orienting and positioning the rotors 21, 23 along the axes of the second pair when required, as illustrated in FIG. 4. Thus, this embodiment allows a two-dimensional displacement. The manipulator 13 of this thruster 1 may advantageously be provided with a pivot 25, thereby allowing orientation and positioning of the rotors 21, 23 along the axes of rotation of the third pair. This preferred embodiment thus allows creating a net thrust in a more refined manner such as, for example, 32° x, 18° y and 179° z, not illustrated. In the embodiment illustrated in FIGS. 3 and 4, each of the rotors 21, 23 are provided with a load 27, 29 connected thereto. Preferably, the loads 27, 29 have a substantially evenly distributed mass, such as a disk for example. This allows the generation of a stronger reacting torque and consequently, the rotation of the vehicle is greater.

FIG. 6 illustrates another preferred embodiment provided with 6 rotors. Each of the rotors respectively extends along each of the axes of rotation of each of the three pairs. This embodiment allows the propulsion of a vehicle in a three-dimensional environment without requiring a manipulator.

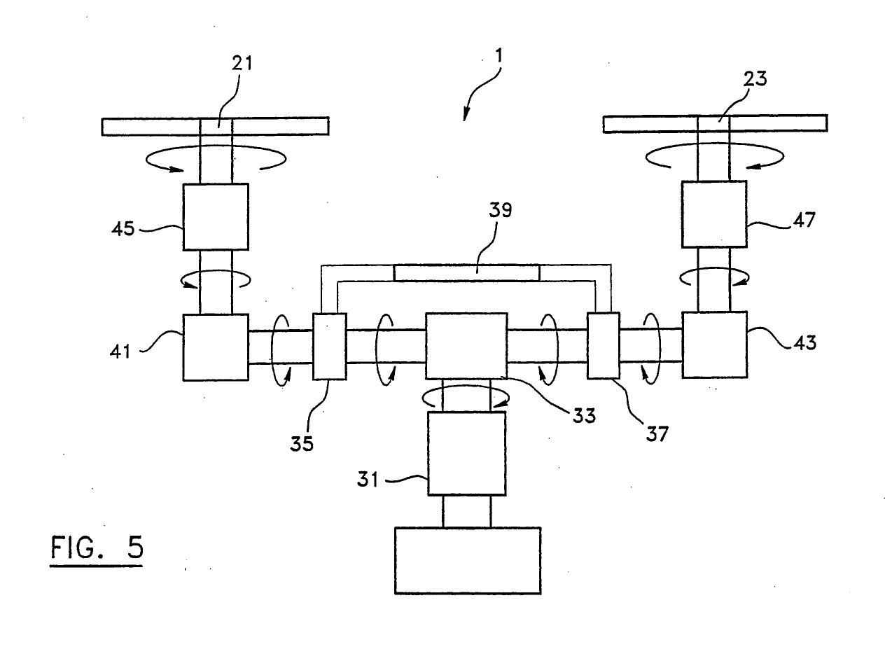

FIG. 5 illustrates another preferred embodiment allowing a three dimensional displacement. The illustrated thruster 1 is provided with two rotors 21, 23 and the actuator means comprises a single electrical motor 31. This thruster is also provided with a differential 33, two clutches 35, 37, a control system 39, two gearings 41, 43 for changing the axis of rotation of the rotors 21, 23 and two reduction gears 45, 47 for reducing the rotating speed of the rotors 21, 23 and thus increasing the torque thereof.

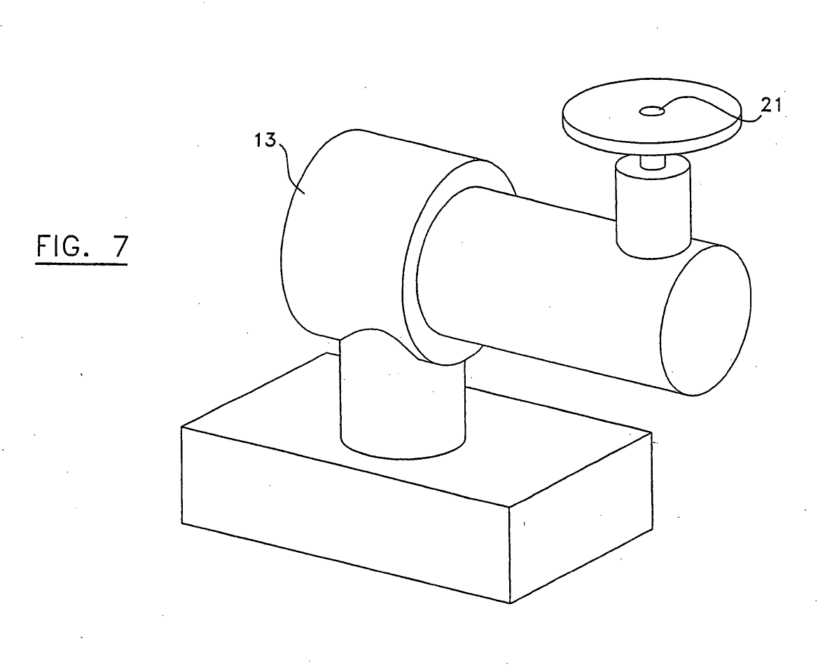

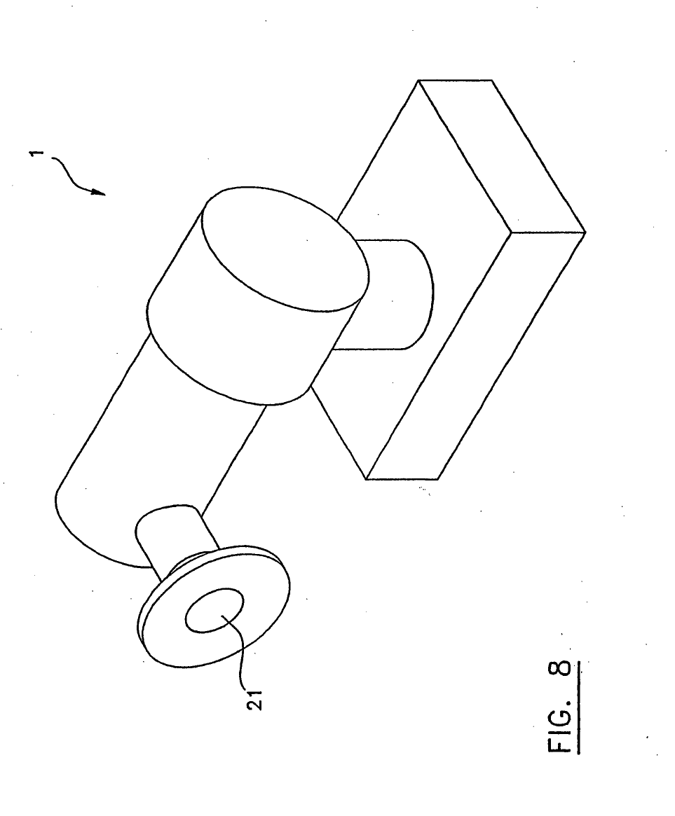

FIGS. 7 and 8 illustrate another preferred embodiment of the thruster of the present invention. In this embodiment, the rotating means comprises a single rotor 21 that is successively swivelled from the first axis to the second axis of rotation. In FIG. 7, the rotor 21 is positioned along the first axis of rotation of the first pair of axes. In FIG. 8, the rotor 21 has been swivelled for extending on the other side of the vehicle (not shown). Moreover, the rotor 21 has also been pivoted for extending in another plane and thereby propelling and directing the vehicle in another direction. For that, the thruster 1 is advantageously provided with a manipulator 13. Any convenient arrangement can be used for that purpose, as will be apparent for any person skilled in the art.

In the preferred embodiments presented above, the rotating means comprises one or several rotors that generate reacting torque. However, it should be understood that any other convenient means generating a reacting torque could also be envisaged. For example, the rotating means may comprise one or several reaction wheels.

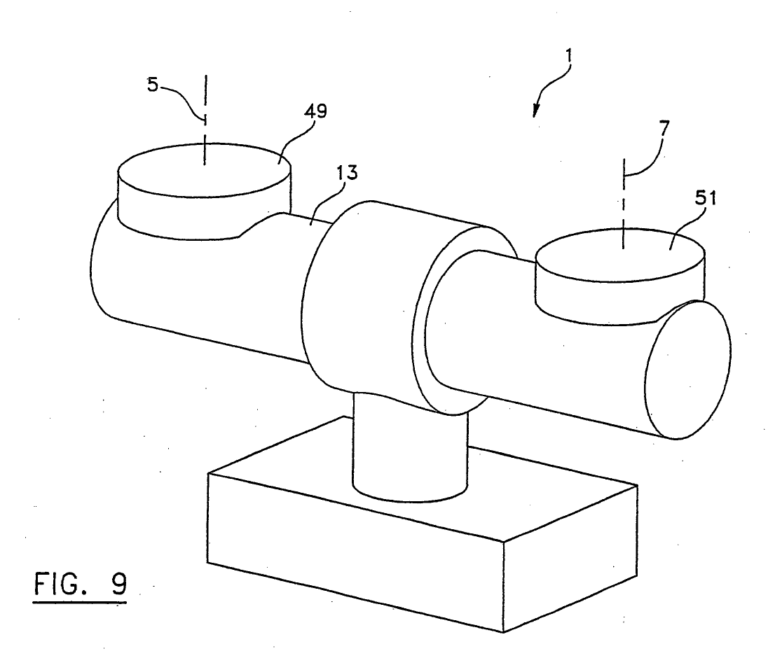

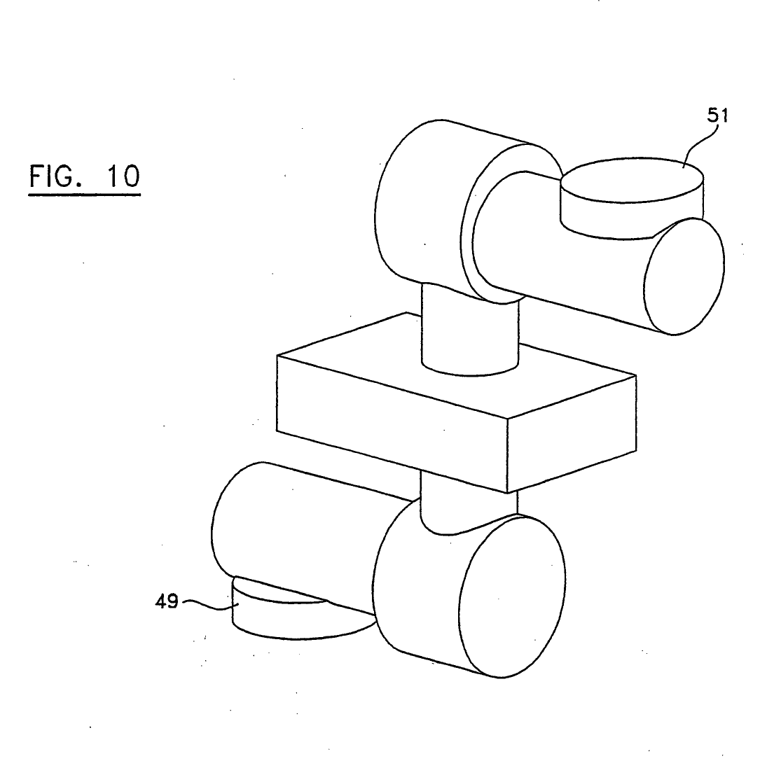

FIGS. 9 and 10 show two other preferred embodiments of the thruster of the present invention wherein the rotating means comprises two reaction wheels 49, 51, each one respectively extending along each of the first and second axis of rotation 5, 7. These thrusters may also have a manipulator 13 for orienting and positioning the reaction wheels 49, 51 along the axes of the second or the third pair when required, as explained above. FIG. 9 shows a thruster 1 wherein the two reaction wheels 49, 51 are coplanar while FIG. 10 shows a thruster wherein the two reaction wheels 49, 51 extend in two distinct planes which are parallel to each other.

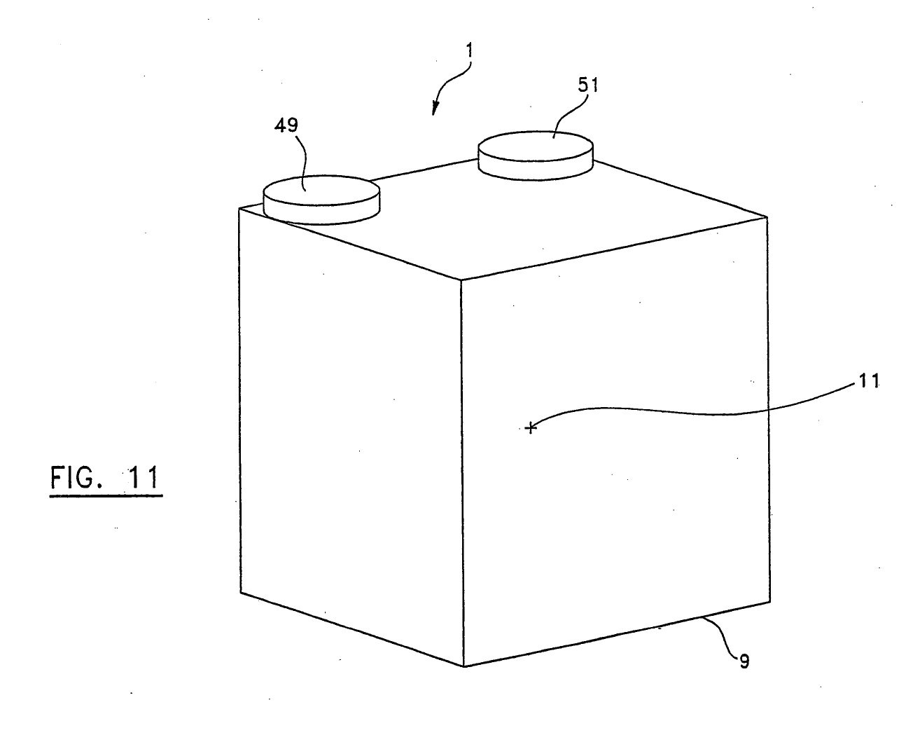

FIG. 11 shows another embodiment of the thruster of the present invention that is mounted on a vehicle 9. As can be seen, the two reactions wheels 49, 51 extend opposite to each other with respect to the center of mass 11 of the vehicle 9. It is worth mentioning that the reaction wheels 49, 51 do not require being in alignment with the center of mass 11 of the vehicle 9, but they have to be off-centered. This structure is different from existing Attitude Control systems that direct the reaction wheels' center axes towards the center of mass of the vehicle.

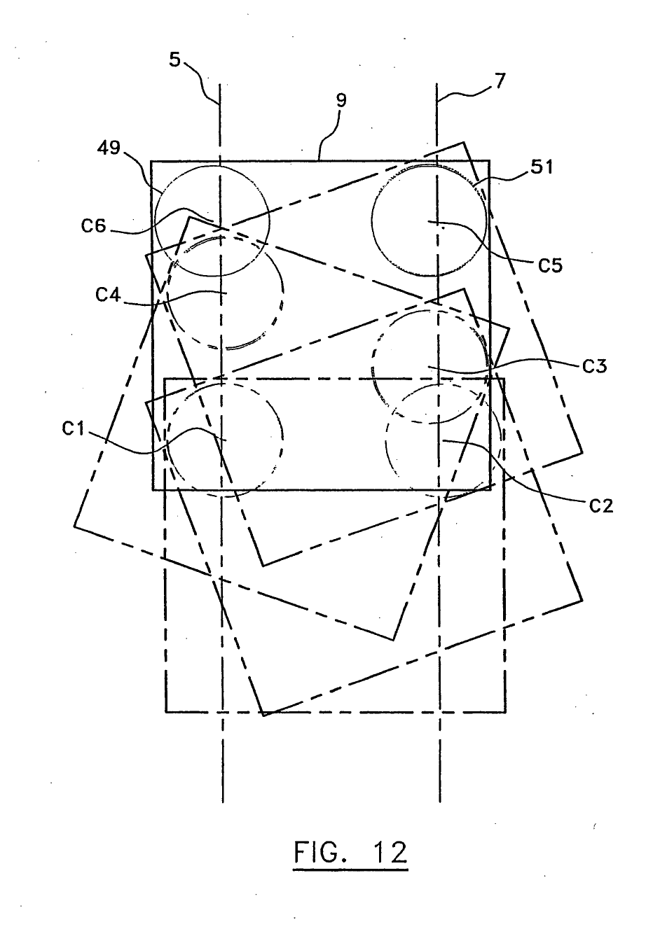

FIG. 12 illustrates a displacement of the vehicle 9 of FIG. 11. As can be seen, the thruster is characterized by its ability to propel and direct the vehicle 9 in any given direction on a plane. The vehicle 9 is firstly rotated about the first axis of rotation 5 and then, about the second axis of rotation 7, to propel the vehicle 9. Indeed, from its initial position, where reaction wheel 49's axis is located at C1 and reaction wheel 51's axis is located at C2, a torque is applied to reaction wheel 49 so that the reaction torque will rotate the whole embodiment so that reaction wheel 51's axis is now located at C3. In a similar but opposite fashion, reaction wheel 49's axis is rotated from C1 to C4. Again, reaction wheel 51's axis is rotated from C3 to C5. Finally, reaction wheel 49's axis is rotated from C4 to C6. The net displacement is to move the vehicle 9 from its initial position C1-C2 to its final position C6-C5. As can be appreciated, this enables the vehicle to turn to any angle and to propel and direct it in any direction on that plane.

The inventor demonstrated this by modifying a small hovercraft with two motors, each one rotating a load in a horizontal fashion. The apparatus measuring 16 inches moved forward for a distance of 38 inches in 61 seconds.

In the previously described displacement sequence, each one of the first and second rotational movements of the rotating means was alternately actuated. Nevertheless, it should be mentioned that the rotational movements could be simultaneously actuated. Moreover, for providing a more convenient thruster, the rotational movements are advantageously actuated in opposite directions.

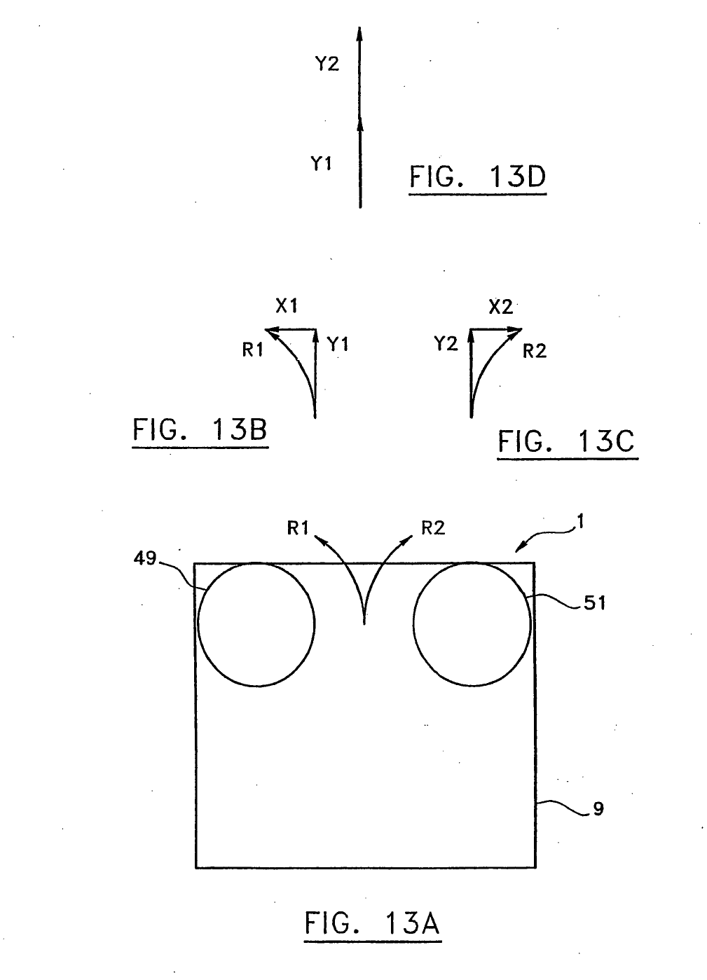

FIGS. 13A to 13D illustrate the various forces at work when the two reaction wheels 49, 51 are simultaneously rotated and produce simultaneous rotation torques R1 and R2. FIG. 13B shows the two angular momentum vectors, X1 and Y1 that depict the angular Reaction torque R1. Similarly, FIG. 13C shows the two angular momentum vectors, X2 and Y2 that depict the angular Reaction torque R2. When the two rotations are combined, the X-axis vectors cancel one another and as shown in FIG. 13D, the Y-axis vectors, Y1 and Y2 are combined.

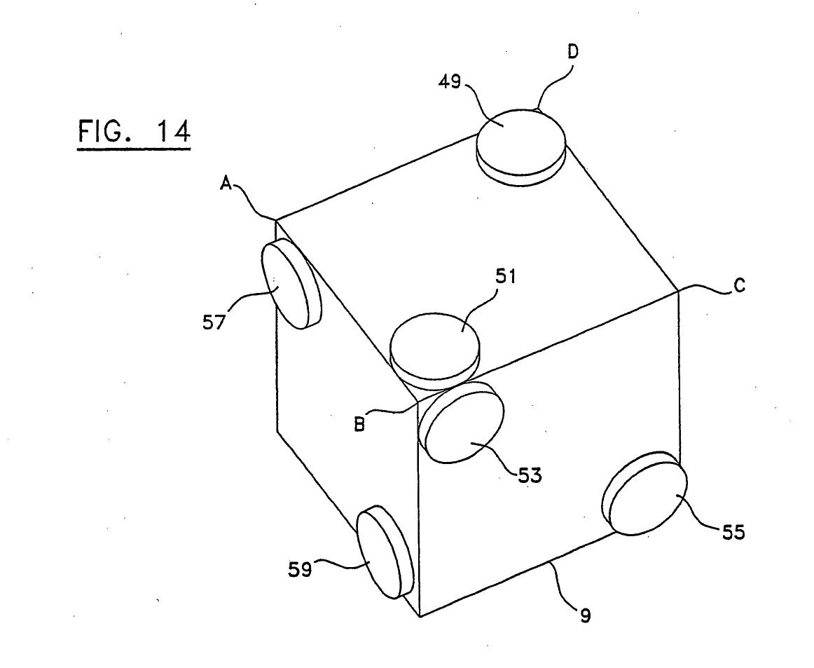

FIG. 14 illustrates another preferred embodiment of the thruster of the present invention having 6 reactions wheels 49, 51, 53, 55, 57, 59 fixed to the vehicle 9 so that it can be propelled and directed in a three-dimensional environment such as space. The reaction wheels of each plane are separated as much as possible to allow the greatest rotation within the vehicle from each reaction wheel 49, 51, 53, 55, 57, 59 to the center of mass.

Not illustrated is a further preferred embodiment where the thruster is enclosed to isolate it from its surroundings.

As described above, the thruster of the present invention is based on the acceleration of reaction wheels and obviously, reaction wheels cannot be accelerated endlessly. To slow and stop the rotation of the reaction wheels, different techniques are used in prior art. In low earth orbit, satellites can use the earth's magnetic field with magnetic torquers to achieve this end. In high earth orbit, satellites rely on small thruster using propellant to do this task.

In two distinct further embodiments of the present invention that will be described hereinafter, the thruster is provided with a particular structure intended to achieve a simple reaction wheels momentum unloading procedure that does not require the use of propellant as the prior art devices.

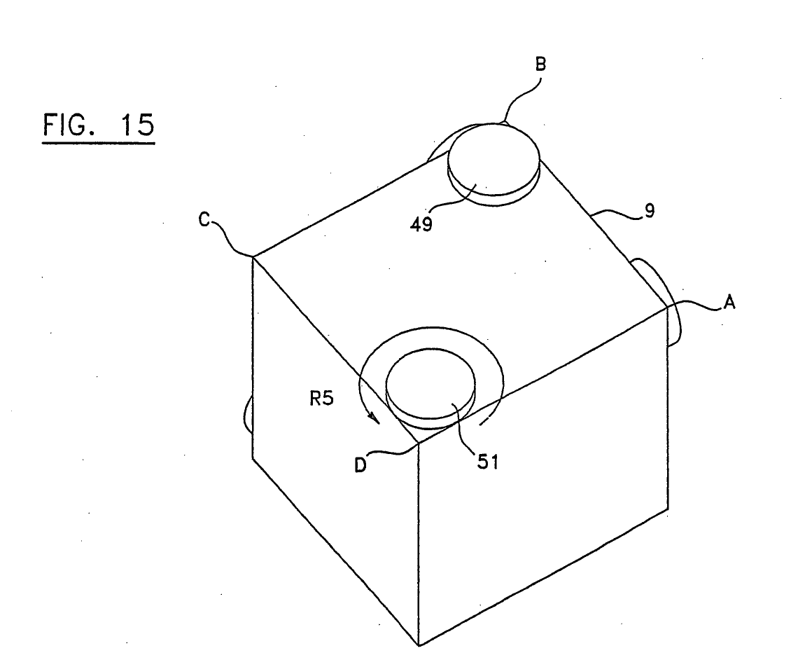

FIG. 15 illustrates a first reaction wheels momentum unloading procedure. When rotors of reaction wheels 49 or 51 on one plane A-B-C-D have attained their optimum rotating velocity and the reaction wheels 53, 55, 57, 59 on the perpendicular planes are stopped, one reaction wheel 49 or 51 is activated to rotate the whole embodiment to the opposite direction. Then the direction of the reaction wheels 49, 51 are reversed so that they can continue being accelerated in their previous direction thus initially slowing down the reaction wheels 49, 51.

Thus, as an exemplary detailed procedure, reaction wheel 51 is rotating in a clockwise direction and reaction wheel 49 is rotating in a counter-clockwise direction, though no torque is applied to either. Reaction wheels 53, 55, 57, 59 are stopped. A torque is applied to reaction wheel 51 so that it produces enough reaction torque R5 to turn round the vehicle. Once the vehicle has been completely turned around, the reaction wheels 49, 51 are still rotating, respectively in a counter-clockwise and clockwise direction. Now, the reaction wheels' motors rotational direction are reversed to apply a clockwise torque to reaction wheel 49 and a counter-clockwise torque to reaction wheel 51, thereby producing a counter-clockwise reaction torque about reaction wheel 49's axis and a clockwise reaction torque about reaction wheel 51's axis thus initially slowing down the reaction wheels 49, 51 while propelling and directing the vehicle in the direction previously held.

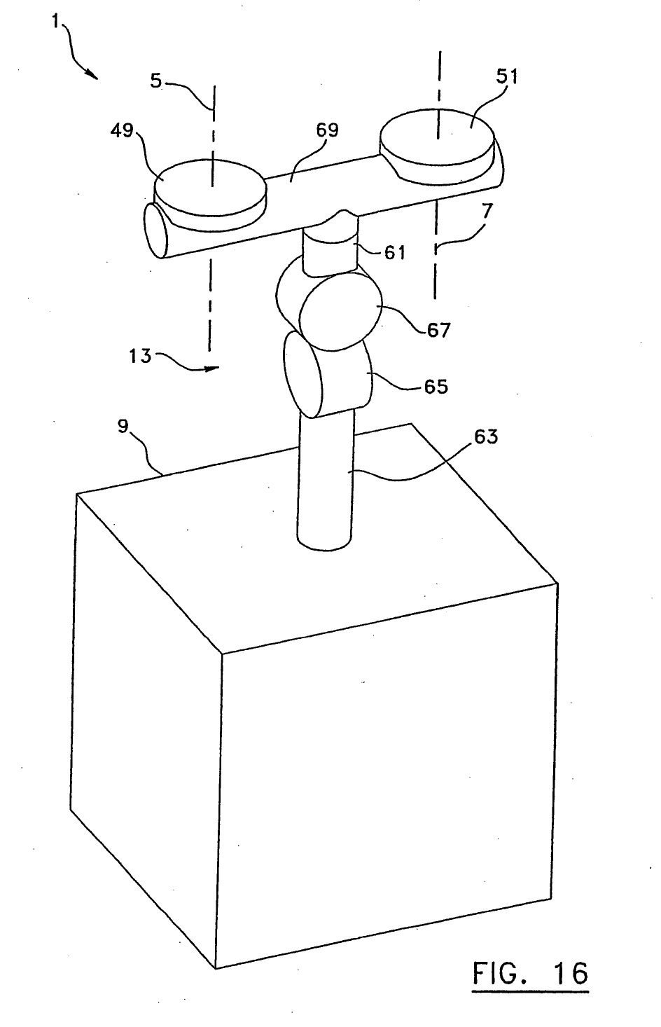

FIG. 16 illustrates another preferred embodiment of the thruster of the present invention that allows achieving a reaction wheels momentum unloading procedure. The thruster 1, mounted on the vehicle 9, is provided with a first and a second reaction wheels 49, 51 and a manipulator 13 having a yaw joint 61 for permuting each of the first and second reaction wheels 49, 51 along the first and second axes of rotation 5, 7. The manipulator 13 also has a lower sleeve 63, a roll joint with actuating system 65 and a pitch joint with actuating system 67. The yaw joint 61 is provided with an actuating system and a rotating arm 69. The manipulator 13 enables the reaction wheels 49, 51 to be placed on three different planes in order to propel and direct the embodiment in different directions in space. The manipulator 13 may also orient the reaction wheels 49, 51 in any plane in order to propel and directing the vehicle 9 in a particular predetermined direction. The manipulator 13 can have many configurations, such as tracks, but they would be equivalent to a person skilled in the field.

The manipulator 13 may advantageously be a remote manipulator system, having actuators, joints, and connectors of electrical current and signals and of optical signals. Such a remote manipulating system may move in many directions, more particularly with its roll joint 65, pitch joint 67 and yaw joint 61. Such a remote manipulator system is actually used in the space shuttle and is known as CANADARM™. This embodiment can be advantageous when the vehicle is so massive as to require a large amount of energy to rotate it as compared to the energy required to rotate solely the reaction wheels 49, 51 and the manipulator 13. It is also advantageous when the vehicle needs to conserve the same attitude for example when it is pointed towards somewhere. It is also useful to simplify the momentum unloading procedure. This embodiment is preferred because most functions of satellites require a constant attitude.

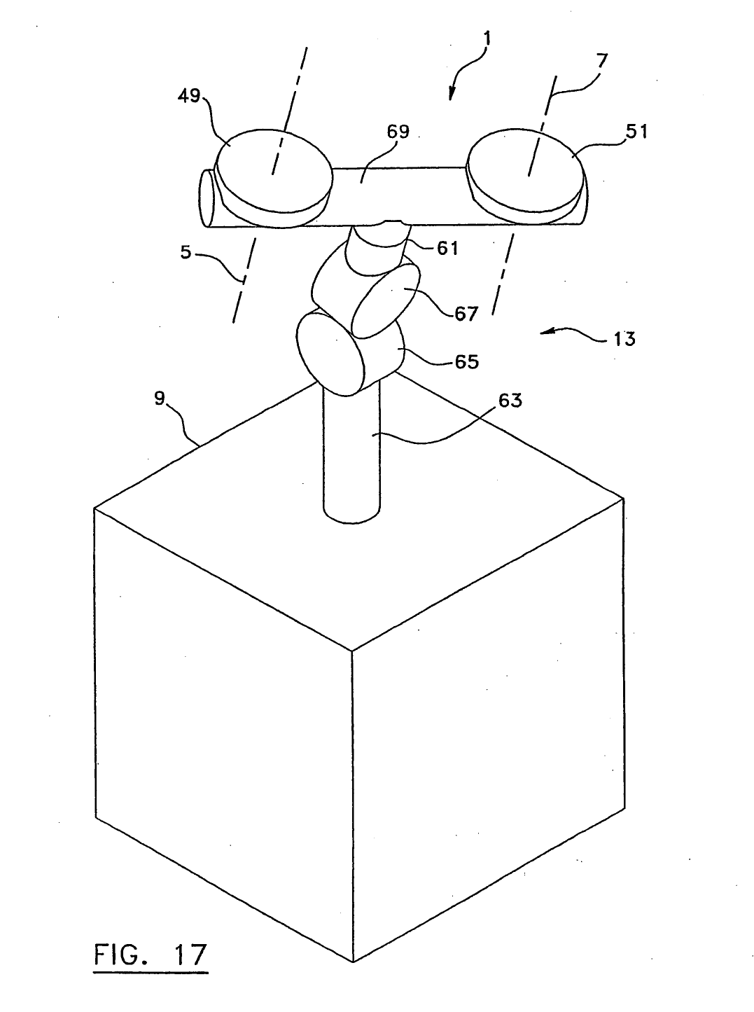

FIG. 17 illustrates the embodiment of FIG. 16 wherein the pitch angle and the yaw angle have been altered. The reaction wheel 49 is rotating in a clockwise direction and reaction wheel 51 is rotating in a counter-clockwise direction, though no torque is applied to either. Since the yaw joint 61 is the topmost joint, it can be easily actuated to turn around the reaction wheels 49, 51 while keeping the same plane. Once this is done, the direction of the reaction wheels torque is reversed so that when the torques are applied on the reaction wheels 49, 51, they will act against their current direction of rotation, enabling them to continue producing a reaction torque as initially without loss of propellant or time and without changing the spacecraft's attitude.

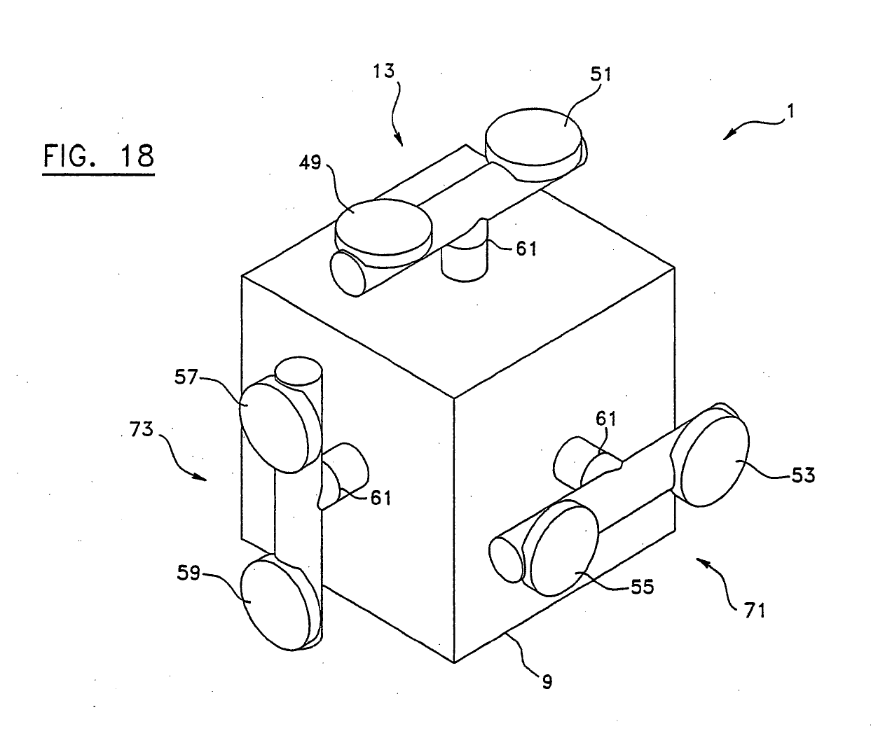

Referring now to FIG. 18, there is shown another preferred embodiment of the thruster of the present invention that allows achieving a reaction wheels momentum unloading procedure. In the illustrated embodiment, the rotating means comprises three sets of a first and a second reaction wheels. Each of the reaction wheels 49, 51, 53, 55, 57, 59 extends along one of the axes of rotation of each of the pairs of axes of rotation. The thruster is further provided with three manipulators 13, 71, 73, each having a yaw joint 61. Each set of first and second reaction wheels is mounted on each of the manipulators for allowing a permutation of each of the first and second reaction wheels along the first and second axes of rotation of each of the pairs.

As previously mentioned, there is a need to spin spacecrafts. So, there is provided another preferred embodiment of the thruster of the present invention allowing enabling controlled spinning of the vehicle on which the thruster is mounted.

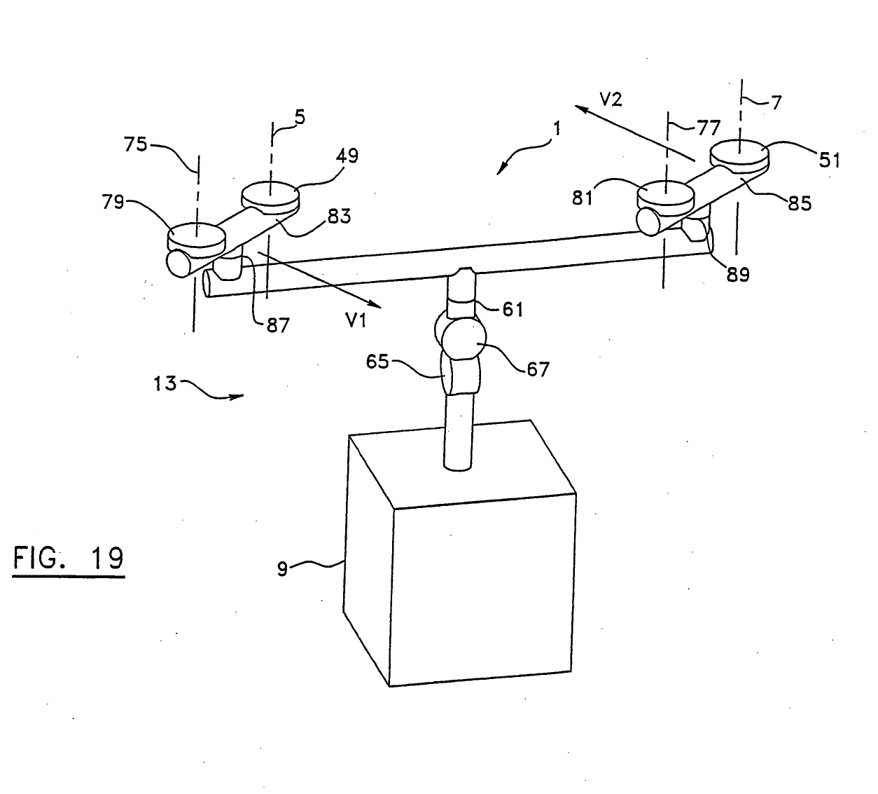

Referring now to FIG. 19, each of the first and second axes of rotation 5, 7 is associated with an additional adjacent twin axis of rotation 75, 77 parallel thereto and off-centered from the center of mass of the vehicle 9. The rotating means further comprises a first, a second, a first twin and a second twin reaction wheels, 49, 51, 79, 81. Each of the reaction wheels respectively extends along one of the axes of rotation 5, 7, 75, 77. Preferably, the reactions wheels 49, 51, 79, 81 are coplanar. The thruster 1 is further provided with a manipulator 13 having two rotating arms 83, 85. Each of the rotating arms 83, 85 respectively receives one of the first and second reaction wheels 49, 51 and the corresponding twin reaction wheel 79, 81 for respectively rotating the corresponding axes of rotation around each other, thereby rotating the corresponding reaction wheels around each other. The manipulator 13 preferably comprises a pitch joint 65, a roll joint 67, and yaw joints 61, 87 and 89. The rotating arms 83, 85 mounting the reaction wheels are turned to impart a couple illustrated by vectors V1 and V2 that spin the whole assembly when all joints are held fast.

When reaction torques R1 and R2 generated by reaction wheels 49, 79, preferably acting in the same direction, are combined they produce a resulting vector V1. Similarly, when reaction torques R3 and R4 generated by reaction wheels 51, 81, preferably acting in the same direction, are combined they produce a resulting vector V2. The two vectors V1, V2 create an angular momentum that spins the whole assembly.

As can be easily understood by a person skilled in the art, this embodiment also allows performing the reaction wheels momentum unloading procedure.

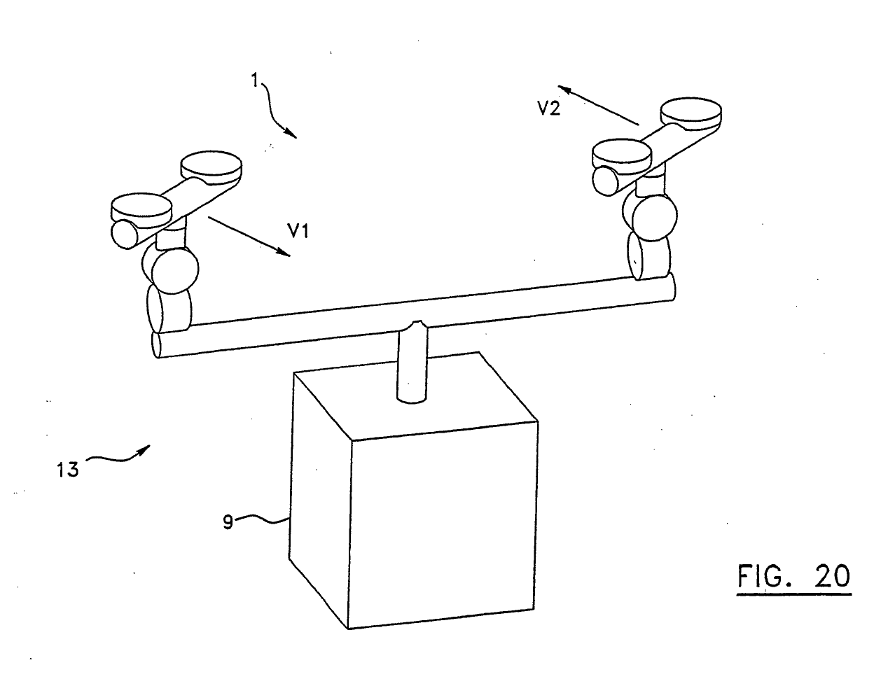

FIG. 20 illustrates another preferred embodiment of the thruster of the present invention which is quite similar to the previous embodiment of FIG. 19 and which allows to spin the vehicle on which the thruster is mounted while also allowing performing the reaction wheels momentum unloading procedure.

The present invention also concerns a method for propelling a vehicle without interacting with environment. The method comprises the steps of:
actuating a first rotational movement in a clockwise direction around a first axis of rotation off-centered from a center of mass of the vehicle thereby generating a first reacting torque in a counter-clockwise direction which causes a pivotal movement of the vehicle around the first axis of rotation in the counter-clockwise direction;
actuating a second rotational movement in a counter-clockwise direction around a second axis of rotation off-centered from the center of mass of the vehicle and extending opposite to the first axis of rotation with respect to the center of mass of the vehicle, the second rotational movement generating a second reacting torque in a clockwise direction which causes a pivotal movement of the vehicle around the second axis of rotation in the clockwise direction; and
controlling an actuating of the first and second rotational movements to impart propulsion and direction to the vehicle.

There is also provided a further embodiment of the previous method for spinning the vehicle. Accordingly, in the present method for propelling and directing a vehicle without interacting with its environment, each of the first and second axes of rotation is associated with an additional adjacent twin axis of rotation parallel thereto and off-centered from the center of mass of the vehicle. The rotating means further comprises a first, a second, a first twin and a second twin reaction wheel. Each of the reaction wheels respectively extends along one of the axes of rotation. The method further comprises the step of spinning the vehicle that comprises the sub-steps of:
rotating the first and the corresponding twin axes of rotation around each other for rotating the corresponding reaction wheels around each other; and
rotating the second and the corresponding twin axes of rotation around each other for rotating the corresponding reaction wheels around each other, thereby generating an angular momentum spinning the vehicle.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention. For example, as maintenance in space is a difficult concern, one or more spare reaction wheels may be provided.

1. A thruster for propelling and directing a vehicle without interacting with environment, said thruster comprising:
rotating means having a pair of a first and a second axis of rotation, connectable to the vehicle such that each of said first and second axis of rotation extends opposite to each other with respect to a center of mass of the vehicle;
actuator means for actuating a first and a second rotational movements of said rotating means respectively around each of said first and second axis of rotation, the first rotational movement being actuated in a clockwise direction thereby generating a first reacting torque in a counter-clockwise direction which causes a pivotal movement of the vehicle around said first axis of rotation in said counter-clockwise direction, the second rotational movement being actuated in a counter-clockwise direction thereby generating a second reacting torque in a clockwise direction which causes a pivotal movement of the vehicle around said second axis of rotation in said clockwise direction; and
a control mechanism to control and coordinate the actuator means to impart propulsion to the vehicle.

2. The thruster for propelling and directing a vehicle without interacting with environment according to claim 1, wherein said first and second axes of rotation extend in a substantially parallel relationship.

3. The thruster for propelling and directing a vehicle without interacting with environment according to claim 1, wherein said rotating means comprises a first and a second rotor, each extending along one of said first and second axis of rotation.

4. The thruster for propelling and directing a vehicle without interacting with environment according to claim 3, wherein said first and second rotors are coplanar.

5. The thruster for propelling and directing a vehicle without interacting with environment according to claim 3, wherein each of said first and second rotors are provided with a load connected thereto.

6. The thruster for propelling and directing a vehicle without interacting with environment according to claim 1, wherein said rotating means comprises a first and a second reaction wheels, each extending along one of said first and second axis of rotation.

7. The thruster for propelling and directing a vehicle without interacting with environment according to claim 6, wherein each of said first and second reaction wheels are coplanar.

8. The thruster for propelling and directing a vehicle without interacting with environment according to claim 1, wherein said rotating means comprises a reaction wheel, said thruster further comprising a manipulator for alternately positioning said reaction wheel along each of said first and second axis of rotation.

9. The thruster for propelling and directing a vehicle without interacting with environment according to claim 1, wherein said rotating means comprises a rotor, said thruster further comprising a manipulator for alternately positioning said rotor along each of said first and second axis of rotation.

10. The thruster for propelling and directing a vehicle without interacting with environment according to claim 1, wherein said rotating means further has a second pair of axes of rotation, each of said axes of rotation of said second pair extending opposite to each other with respect to said center of mass of said vehicle, each of said pairs extending respectively substantially transversally and longitudinally on said vehicle for allowing a two-dimensional propulsion of said vehicle.

11. The thruster for propelling and directing a vehicle without interacting with environment according to claim 10, wherein said rotating means comprises a first and a second reaction wheel, said thruster further comprising a manipulator for sequentially positioning each of said first and second reaction wheel respectively along each of said first and second axis of rotation of each of said pairs of axes of rotation.

12. The thruster for propelling and directing a vehicle without interacting with environment according to claim 11, wherein said manipulator comprises a yaw joint for permuting each of said first and second reaction wheels along said first and second axis of rotation of each of said pairs.

13. The thruster for propelling and directing a vehicle without interacting with environment according to claim 10, wherein said rotating means further has a third pair of axes of rotation, each of said axes of rotation of said third pair extending opposite to each other with respect to said center of mass of said vehicle, said third pair extending substantially perpendicularly to said second pair for allowing the propulsion of said vehicle in a three dimensional environment.

14. The thruster for propelling and directing a vehicle without interacting with environment according to claim 13, wherein said rotating means comprises a first and a second reaction wheel, said thruster further comprising a manipulator for sequentially positioning each of said first and second reaction wheels respectively along each of said first and second axis of rotation of each of said pairs of axes of rotation.

15. The thruster for propelling and directing a vehicle without interacting with environment according to claim 14, wherein said manipulator comprises a yaw joint for permuting each of said first and second reaction wheels along said first and second axis of rotation of each of said pairs.

16. The thruster for propelling and directing a vehicle without interacting with environment according to claim 15, wherein said yaw joint of said manipulator is a topmost joint.

17. The thruster for propelling and directing a vehicle without interacting with environment according to claim 13, wherein said rotating means comprises three sets of a first and a second reaction wheels, each of said reaction wheel extending along one of said axes of rotation of each of said pairs.

18. The thruster for propelling and directing a vehicle without interacting with environment according to claim 17, wherein said thruster further comprises three manipulators having a yaw joint, each set of said three sets of first and second reaction wheels being mounted on each of said manipulators for allowing a permutation of each of said first and second reaction wheel along said first and second axis of rotation of each of said pairs.

19. The thruster for propelling and directing a vehicle without interacting with environment according to claim 6, wherein said thruster further comprises a manipulator having a yaw joint, said first and second reaction wheels being mounted on said manipulator for allowing a permutation of each of said first and second reaction wheel along said first and second axis of rotation.

20. The thruster for propelling and directing a vehicle without interacting with environment according to claim 1, wherein each of said first and second axis of rotation is associated with an additional adjacent twin axis of rotation parallel thereto and off-centered from said center of mass of said vehicle, said rotating means further comprising a first, a second, a first twin and a second twin reaction wheels, each of said reaction wheels respectively extending along one of said axis of rotation, said thruster further comprising a manipulator having two rotating arms, each respectively receiving one of said first and second reaction wheels and the corresponding twin reaction wheels for respectively rotating the corresponding axes of rotation around each other, thereby rotating the corresponding reaction wheels around each other.

21. The thruster for propelling and directing a vehicle without interacting with environment according to claim 20, wherein each of said reaction wheel is coplanar.

22. The thruster for propelling and directing a vehicle without interacting with environment according to claim 13, wherein each of said first and second axis of rotation of each of said pairs is associated with an additional adjacent twin axis of rotation parallel thereto and off-centered from said center of mass of said vehicle, said rotating means further comprising a first, a second, a first twin and a second twin reaction wheel, each of said reaction wheels respectively extending along each of said axes of rotation of one of said pairs, said thruster further comprising a manipulator having two rotating arms, each respectively receiving one of said first and second reaction wheels and the corresponding twin reaction wheel for respectively rotating the corresponding axes of rotation of the corresponding pair around each other, thereby rotating the corresponding reaction wheels around each other, said manipulator further comprising a roll joint, a pitch joint and a yaw joint for sequentially orienting and positioning each of said reaction wheels respectively along the corresponding axis of rotation of each of said pairs.

23. The thruster for propelling and directing a vehicle without interacting with environment according to claim 13, wherein each of said first and second axis of rotation of each of said pairs is associated with an additional adjacent twin axis of rotation parallel thereto and off-centered from said center of mass of said vehicle, said rotating means further comprising three sets of a first, a second, a twin first and a twin second reaction wheels, each of said reaction wheels respectively extending along each of said axes of rotation of each of said pairs, said thruster further comprising three manipulators, each of said manipulators having two rotating arms, each rotating arm respectively receiving one of said first and second reaction wheel and the corresponding twin reaction wheel for respectively rotating the corresponding axes of rotation around each other, thereby rotating the corresponding reaction wheels around each other.

24. The thruster for propelling and directing a vehicle without interacting with environment according to claim 8, wherein said rotating means further comprises at least one spare reaction wheel.

25. The thruster for propelling and directing a vehicle without interacting with environment according to claim 13, wherein said rotating means comprises a reaction wheel, said thruster further comprising a manipulator for alternately positioning said reaction wheel along one of said axes of rotation of said pairs, thereby allowing the propulsion of said vehicle in a three dimensional environment.

26. The thruster for propelling and directing a vehicle without interacting with environment according to claim 13, wherein said rotating means comprises a rotor, said thruster further comprising a manipulator for alternately positioning said rotor along one of said axes of rotation of said pairs, thereby allowing the propulsion of said vehicle in a three dimensional environment.

27. The thruster for propelling and directing a vehicle without interacting with environment according to claim 25, wherein said manipulator is a remote manipulator system.

28. The thruster for propelling and directing a vehicle without interacting with environment according to claim 27, wherein said remote manipulator system comprises a roll joint, a pitch joint and a yaw joint.

29. The thruster for propelling and directing a vehicle without interacting with environment according to claim 1, wherein said vehicle is a hovercraft.

30. The thruster for propelling and directing a vehicle without interacting with environment according to claim 1, wherein said vehicle is a spacecraft.

31. The thruster for propelling and directing a vehicle without interacting with environment according to claim 13, wherein said vehicle is a spacecraft.

32. The thruster for propelling and directing a vehicle without interacting with environment according to claim 1, wherein each of said first and second rotational movement of said rotating means is actuatable in opposite directions respectively around said first and second axis of rotation.

33. The thruster for propelling and directing a vehicle without interacting with environment according to claim 1, wherein each of said first and second rotational movement of said rotating means is alternately actuated.

34. The thruster for propelling and directing a vehicle without interacting with environment according to claim 1, wherein each of said first and second rotational movements of said rotating means are simultaneously actuated.

35. The thruster for propelling and directing a vehicle without interacting with environment according to claim 1, further comprising a power supply operatively connected to said actuator means.

36. The thruster for propelling and directing a vehicle without interacting with environment according to claim 1, wherein said actuator means comprises an electrical motor.

37. The thruster for propelling and directing a vehicle without interacting with environment according to claim 13, wherein the thruster is enclosed from surroundings.

38. The thruster for propelling and directing a vehicle without interacting with environment according to claim 37, wherein said vehicle is contained in a nanotechnological device.

39. The thruster for propelling and directing a vehicle without interacting with environment according to claim 37, wherein said vehicle is a vessel.

40. The thruster for propelling and directing a vehicle without interacting with environment according to claim 1, wherein said vehicle is a toy.

41. The thruster for propelling and directing a vehicle without interacting with environment according to claim 1, wherein said vehicle is a vessel.

42. The thruster for propelling and directing a vehicle without interacting with environment according to claim 1, wherein said vehicle is a nanotechnological device.

43. A method for propelling and directing a vehicle without interacting with environment said method comprising the steps of:
actuating a first rotational movement in a clockwise direction around a first axis of rotation off-centered from a center of mass of the vehicle thereby generating a first reacting torque in a counter-clockwise direction which causes a pivotal movement of the vehicle around said first axis of rotation in said counter-clockwise direction;
actuating a second rotational movement in a counter-clockwise direction around a second axis of rotation off-centered from said center of mass of the vehicle and extending opposite to said first axis of rotation with respect to the center of mass of the vehicle, said second rotational movement generating a second reacting torque in a clockwise direction which causes a pivotal movement of the vehicle around said second axis of rotation in said clockwise direction; and
controlling an actuation of said first and second rotational movements to impart propulsion and direction to said vehicle.

44. The method for propelling and directing a vehicle without interacting with environment according to claim 43, wherein each of said rotational movements is generated by a rotating means.

45. The method for propelling and directing a vehicle without interacting with environment according to claim 43, wherein each of said rotational movement is actuated in opposite directions.

46. The method for propelling and directing a vehicle without interacting with environment according to claim 43, wherein said first and second rotational movement are simultaneously actuated.

47. The method for propelling and directing a vehicle without interacting with environment according to claim 43, wherein each of said first and second rotational movement is alternately actuated.

48. The method for propelling and directing a vehicle without interacting with environment according to claim 43, further comprising the step of actuating a third and a fourth rotational movement in opposite direction respectively around a third and a fourth axis of rotation of a second pair, said third and fourth axis of rotation being off-centered from the center of mass of the vehicle and opposite to each other with respect to the center of mass of said vehicle, each of said pairs of axes of rotation extending respectively substantially transversally and longitudinally on said vehicle for providing a two-dimensional propulsion of said vehicle.

49. The method for propelling and directing a vehicle without interacting with environment according to claim 48, further comprising the step of actuating a fifth and a sixth rotational movement in opposite direction respectively around a fifth and a sixth axis of rotation of a third pair, said fifth and sixth axis of rotation being off-centered from the center of mass of the vehicle and opposite to each other with respect to the center of mass of said vehicle, said third pair of axes of rotation extending substantially perpendicularly to said second pair for allowing the propulsion of said vehicle in a three dimensional environment.

50. The method for propelling and directing a vehicle without interacting with environment according to claim 44, wherein said rotating means comprises a first and a second reaction wheel, each extending along one of said first and second axis of rotation, said method further comprising the step of unloading a momentum of at least one of said reaction wheels, said step of unloading a momentum comprising the sub-steps of:
applying a reacting torque around one of said axes of rotation until said vehicle is rotated by about 180 degrees; and
reversing a direction of rotation of at least one of said reaction wheels, thereby initially slowing down said reaction wheel while propelling and directing said vehicle in a previous direction.

51. The method for propelling and directing a vehicle without interacting with environment according to claim 44, wherein said rotating means comprises a first and a second reaction wheel, each extending along one of said first and second axis of rotation an being mounted on a manipulator having a yaw joint for permuting each of said reaction wheel along said first and second axis of rotation, said method further comprising the step of unloading a momentum of at least one of said reaction wheels, said step of unloading a momentum comprising the sub-steps of:
permuting each of said reaction wheels along said first and second axis of rotation; and
reversing a direction of rotation of each of said reaction wheels, thereby allowing a momentum unloading of each of said reaction wheel while propelling and directing said vehicle towards its previous direction.

52. The method for propelling and directing a vehicle without interacting with environment according to claim 44, wherein each of said first and second axes of rotation is associated with an additional adjacent twin axis of rotation parallel thereto and off-centered from said center of mass of said vehicle, said rotating means further comprising a first, a second, a first twin and a second twin reaction wheels, each of said reaction wheels respectively extending along one of said axes of rotation, said method further comprising the step of spinning the vehicle, said step of spinning the vehicle comprising the sub-steps of:
rotating the first and the corresponding twin axes of rotation around each other for rotating the corresponding reaction wheels around each other; and
rotating the second and the corresponding twin axes of rotation around each other for rotating the corresponding reaction wheels around each other, thereby generating an angular momentum spinning the vehicle.
